(19) United States
(12) Patent Application Publication
(10) Pub. No.: US 2008/0136165 A1
(43) Pub. Date: Jun. 12, 2008

(54) Apparatus for Preventing Pipe Flanges from Accidental Closures

(76) Inventor: Arthur W. Doty, Round Rock, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/773,797

(22) Filed: Jul. 5, 2007

Related U.S. Application Data
(60) Provisional application No. 60/869,689, filed on Dec. 12, 2006.

(51) Int. Cl. F16L 35/00

(52) U.S. Cl. 285/24

(57) ABSTRACT

An apparatus for preventing accidental flange closures is disclosed. A flange spacer having a central opening can be inserted into a gap between two opposing flanges. A shaft that has a thickness smaller than the width of the central opening of the flange spacer can be inserted through an opening on the first flange using a handle on the first end of the shaft. The shaft is subsequently inserted through the flange spacer and through an opening on the second flange. A removable safety pin can be inserted into the second end of the shaft to prevent the shaft from coming loose inadvertently. As such, the flange spacer prevents the opposing flanges from making contact.

### CROSS-REFERENCE TO RELATED APPLICATION

The present application claims the priority of a provisional patent application Ser. No. 60/869,689, filed Dec. 12, 2006, which is incorporated herein by reference.

### BACKGROUND OF THE INVENTION

1. Technical Field

The present invention relates to pipe flanges in general, and in particular to an apparatus for preventing pipe flanges from accidental closures.

2. Description of Related Art

Flanges are protruding edges, rings, or collars located on one or more ends of a pipeline that are utilized to strengthen the pipe and/or to attach the pipe to another pipe or object. When performing maintenance on a pipeline, it is often necessary to separate the opposing flanges of two connected pipelines to access the inside surface of the pipelines.

During maintenance, pipelines are typically under force or may be subjected to inadvertent movements, and serious hand injuries can occur and/or tools can be damaged when two opposing flanges accidentally make contact. Conventional devices utilized to prevent inadvertent flange closures, such as hydraulic jacks, can fail if the device slips out from between the flanges or due to internal hardware errors. Consequently, an improved fail-safe device is needed for preventing accidental flange closures.

### SUMMARY OF THE INVENTION

In accordance with a preferred embodiment of the present invention, two opposing flanges can be held apart by a flange spacer capable of being inserted into a gap between the two opposing flanges. The flange spacer has a central opening. A shaft having a thickness smaller than the width of the central opening of the flange spacer can be inserted through an opening on the first flange using a handle on the first end of the shaft. The shaft is subsequently inserted through the central opening of the flange spacer and through an opening on the second flange. A removable safety pin can be inserted into the second end of the shaft to prevent the shaft from coming loose inadvertently.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a flange spacer and a shaft, in accordance with a preferred embodiment of the present invention;

FIG. 2A illustrates the flange spacer from FIG. 1 being placed between two pipe flanges, in accordance with a preferred embodiment of the present invention;

FIG. 2B illustrates the flange spacer from FIG. 1 secured between two pipe flanges, in accordance with a preferred embodiment of the present invention;

FIG. 3 is a side view of the flange spacer from FIG. 1 being placed against a pipe flange, in accordance with a preferred embodiment of the present invention; and

FIG. 4 is a front view of the flange spacer from FIG. 1 being placed against a pipe flange, in accordance with a preferred embodiment of the present invention.

### DETAILED DESCRIPTION OF A PREFERRED EMBODIMENT

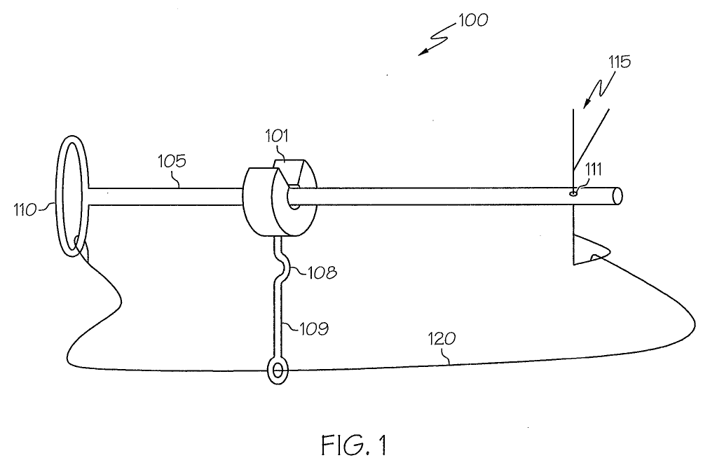

Referring now to the drawings and in particular to FIG. 1, there is depicted an isomeric view of an apparatus for preventing pipe flanges from accidental closures, in accordance with a preferred embodiment of the present invention. As shown, an apparatus 100 includes a flange spacer 101 and a shaft 105. Flange spacer 101 is attached to a handle 109 having a bend 108. Flange spacer 101 is a cylinder having a portion removed. Flange spacer 101 also has a central opening. Although flange spacer 101 is preferably cylindrical in shape and the central opening is preferably round, other shapes, such as a square with a cylindrical hole or a hexagon with a rectangular hole, are also acceptable. Flange spacer 101 can be of various sizes and thickness to fit in corresponding flange sizes. Flange spacer 101, which is preferably made of metal, can be color-coded according to flange class or a maximum compression force.

Shaft 105 includes a handle 110 on one end and a small hole 111 on the opposite end. Shaft 105 fits through the central opening inside flange spacer 101. Since the cross-sectional shape of the central opening inside flange spacer 100 is cylindrical, the cross-sectional shape of shaft 105 is also cylindrical. A safety pin 115 can be inserted through hole 111. Safety pin 115 can be connected to handle 110 via a cable 120 in order to prevent safety pin 115 from being misplaced when safety pin 115 is not in use.

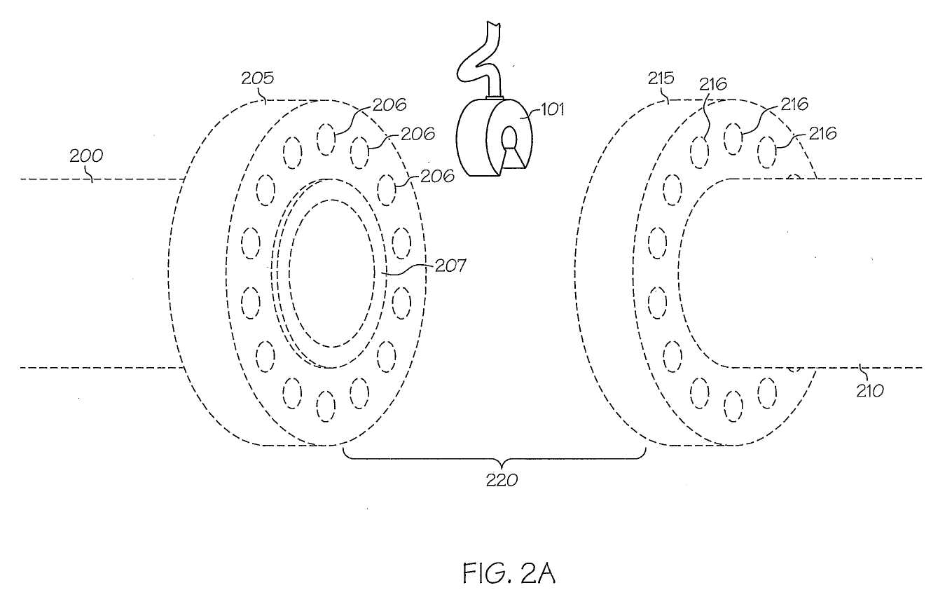

With reference now to FIG. 2A, there is depicted a diagram of flange spacer 101 being placed between pipe flanges 205 and 215, in accordance with a preferred embodiment of the present invention. As shown, pipe flange 205 is part of a pipe 200, and pipe flange 215 is part of a pipe 210. Multiple holes 206 are located along the edge of pipe flange 205. Similarly, multiple holes 216 are located along the edge of pipe flange 215. Pipe flanges 205 and 215 can be held together via nuts and bolts (not shown) placed through holes 206 and 216. A raised face 207 forms an opening for pipe 200 within pipe flange 205. Raised face 207 provides a relatively smooth surface for receiving sealable material such as a gasket (not shown).

After all bolts have been removed from holes 206 and 216, pipe flanges 205 and 215 can be separated apart via conventional tools, such as a flange spreader, that are well-known in the art. Pipe flanges 205 and 215 are preferably separated apart to a gap 220 having a width that is slightly longer than the width of flange spacer 101. Flange spacer 101 is then inserted between pipe flanges 205 and 215, as shown in FIG. 2A. After flange spacer 101 has been inserted between pipe flanges 205 and 215, the force that keeps pipe flanges 205 and 215 apart is released such that flange spacer 101 becomes the means for preventing flanges 205 and 215 from making direct contact with each other.

With reference now to FIG. 2B, there is depicted flange spacer 101 secured between flanges 205 and 215, in accordance with a preferred embodiment of the present invention. As shown, flange spacer 101 is securely fastened between pipe flanges 205 and 215 via shaft 105. Specifically, shaft 105 is inserted through one of holes 206 on pipe flange 205, the central opening within flange spacer 101, and one of holes 216 on pipe flange 215. Safety pin 115 can be inserted through small hole 111 to prevent shaft 105 from slipping through pipe flange 215 inadvertently. Similarly, handle 110 prevents shaft 105 from slipping through pipe flange 205 inadvertently. At this point, a worker can access the inside surfaces of pipes 200 and 210 without the potential danger of pipe flanges 205 and 215 coming into contact inadvertently.

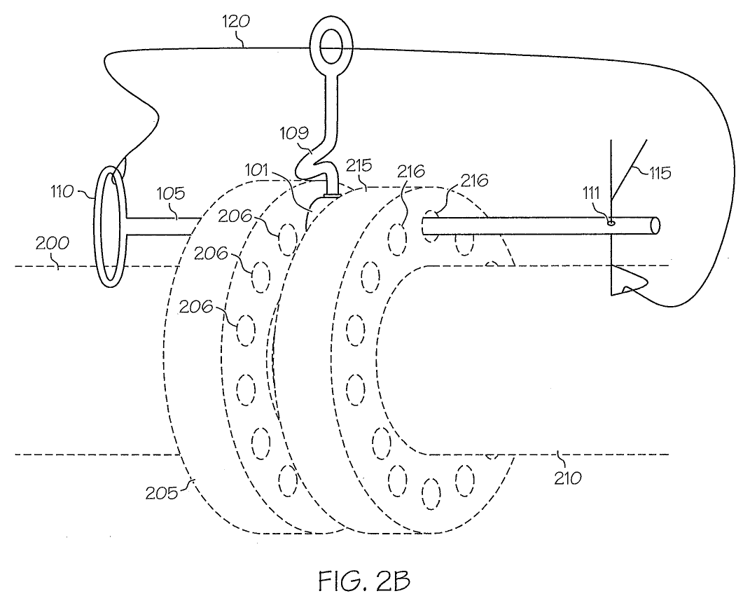

Referring now to FIG. 3, there is depicted a side view of flange spacer 101 being placed against pipe flange 205, in accordance with a preferred embodiment of the present invention. As shown, flange spacer 101 is attached to handle 109 having bend 108. When flange spacer 101 is in use, bend 108 prevents flange spacer 101 from slipping over raised face 207 as long as bend 108 is resting on the outer edge of pipe flange 205.

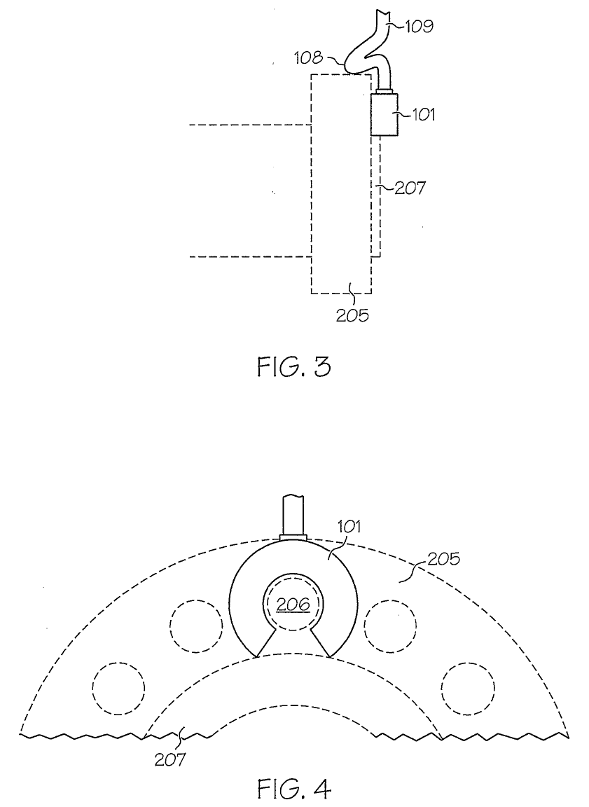

With reference now FIG. 4, there is depicted a front view of flange spacer 101 being placed against pipe flange 205, in accordance with a preferred embodiment of the present invention. As shown, the central opening of pipe flange 205 is aligned with hole 206 on pipe flange 205. In addition, the two bottom edges of flange spacer 101 is resting on the outer edge of raised face 207. When flange spacer 101 is in use, a shaft, such as shaft 105 from FIG. 1, is placed in holes 206 and 216 as well as the central opening of flange spacer 101 to maintain the position of flange spacer 101 in relation to pipe flange 205 as shown in FIG. 4.

As has been described, the present invention provides an apparatus for preventing pipe flanges from accidental closures. It is understood that the use herein of specific names are for example only and not meant to imply any limitations on the invention. The present invention may be implemented with different nomenclature or terminology and associated functionality utilized to describe the above devices without limitation.

While the invention has been particularly shown and described with reference to a preferred embodiment, it will be understood by those skilled in the art that various changes in form and detail may be made therein without departing from the spirit and scope of the invention.

What is claimed is:

1. An apparatus for preventing pipe flanges from accidental closures, said apparatus comprising:
a flange spacer to be inserted between two pipeline flanges for preventing said two pipeline flange from coming into contact with each other, wherein said flange spacer includes a central opening; and
a shaft having a circumference smaller than a circumference of said central opening, wherein said shaft is adapted to be inserted into said opening of said flange spacer.

2. The apparatus of claim 1, wherein said shaft includes a handle connected to a first end of said shaft.

3. The apparatus of claim 2, wherein said shaft includes a small opening located at a second end of said shaft.

4. The apparatus of claim 3, wherein said shaft includes a removable safety pin capable of being inserted into said small opening.

5. The apparatus of claim 1, wherein said flange spacer is cylindrical in shape.

6. The apparatus of claim 1, wherein said flange spacer is in square shape.

7. The apparatus of claim 1, wherein said flange spacer includes a handle having a bend for preventing said flange space from slipping over a raised face on a pipe flange during use.

8. The apparatus of claim 1, wherein said flange spacer is color-coded according to flange class.
